(19) United States
(12) Patent Application Publication
(10) Pub. No.: US 2012/0221495 A1
(43) Pub. Date: Aug. 30, 2012

(54) DIGITAL WEIGHT LOSS AID

(76) Inventor: DAVID LANDERS, Edgewater, NJ (US)

(21) Appl. No.: 13/036,151

(22) Filed: Feb. 28, 2011

(51) Int. Cl. G06N 5/02; G06F 15/18

(52) U.S. Cl. 706/12; 706/46

(57) ABSTRACT

A health management system provides instantaneous feedback as to the relationship of food items and exercise to one's fitness level, including one's weight. The health management system does not require the user to count calories, either on the intake or expenditure side of the weight loss paradigm. Rather, the health management system may use icons and graphic displays, without units, to provide a user-friendly interface. The health management system can integrate weight, food intake and activity and can learn the individual's unique response to each element to predict the direction of weight gain or loss.

### BACKGROUND OF THE INVENTION

The present invention relates to health and fitness devices and, more particularly, to an apparatus and software for monitoring the health and fitness of an individual.

Counting calories is an inherently inaccurate process and cannot be successfully used to predict weight loss because food items and activity have wide variation compared to actual calories ingested or burned. Conventional weight loss programs often require the user to track food intake, which may be subjective. For example, one person's serving size for a particular food item may be different from another person's serving size. Moreover, weighing and measuring food items may be difficult—not only to do, but also difficult to maintain doing over a course of a weight loss program. In addition, tracking calories burned may be difficult, as the number of calories burned may vary from exercise to exercise and person to person.

As can be seen, there is a need for a health management system that may be easy to use and that may adapt to an individual's response to food intake and exercise.

### SUMMARY OF THE INVENTION

In one aspect of the present invention, a method for managing a user's health comprises entering consumed calories into a device, the consumed calories being entered as a graphical representation of a food portion; inputting activity into the device; and predicting the user's fitness level based on calories consumed and calories burned due to activity.

In another aspect of the present invention, a system for managing a user's health comprises a device adapted to run software, the software including program code adapted to receive consumed calories entered by the user, the program code providing a graphical representation of a food portion, wherein the food portion may be graphically adjusted by the user; program code adapted to receive an input of activity of the user; program code adapted to receive an input of weight of the user; program code adapted to predict the user's fitness level based on calories consumed and calories burned due to activity; and program code adapted to adjust the user's fitness level prediction based on historic measurements of the calories consumed, the calories burned and the weight of the user.

In a further aspect of the present invention, a method for managing a user's health comprises entering consumed calories into a device, the consumed calories being entered as a graphical representation of a food portion; inputting activity into the device; measuring a weight of the user on a periodic basis; predicting the user's fitness level based on calories consumed and calories burned due to activity; and adjusting the user's fitness level prediction based on historic measurements of the calories consumed, the calories burned and the weight of the user.

These and other features, aspects and advantages of the present invention will become better understood with reference to the following drawings, description and claims.

### BRIEF DESCRIPTION OF THE DRAWINGS

FIG. 1 is a front view of a sample screen display of a health management system displayed on a digital device, according to an exemplary embodiment of the present invention;

FIG. 2 is a front view of a second sample screen display of the health management system of FIG. 1;

FIG. 3 is a front view of a third sample screen display of the health management system of FIG. 1;

FIG. 4 is a front view of a fourth sample screen display of the health management system of FIG. 1;

FIG. 5 is a front view of a fifth sample screen display of the health management system of FIG. 1;

FIG. 6 is a front view of a sixth sample screen display of the health management system of FIG. 1; and

FIG. 7 is a sample graphical output of the health management system of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a health management system for providing instantaneous feedback as to the relationship of food items and exercise to one's fitness level, including one's weight. The health management system does not require the user to count calories, either on the intake or expenditure side of the weight loss paradigm. Rather, the health management system may use icons and graphic displays, without units, to provide a user-friendly interface. The health management system can integrate weight, food intake and activity and can learn the individual's unique response to each element to predict the direction of weight gain or loss.

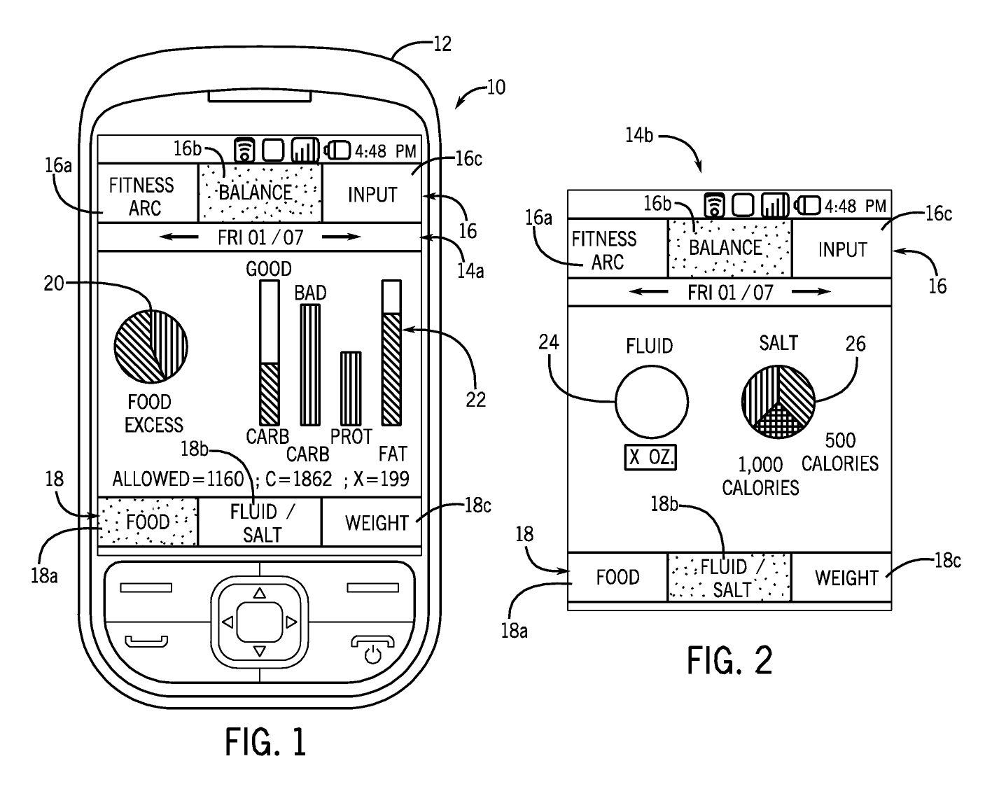

Referring to FIG. 1, there is shown a health management system 10. The health management system 10 may be a software program that is run on a digital device 12, such as a smart phone, tablet computer, or the like. In some embodiments, the digital device 12 may run an Android® based operating system. Alternatively, the health management system 10 may be a stand-alone device, having the software pre-installed thereupon. For example, the health management system 10 may be a wrist-watch like or some other digital device specifically adapted to run software for providing the functionality as described below.

The health management system 10 may include a plurality of software program codes for displaying data, calculating data, receiving data and the like. When the software is run on the digital device 12, primary input buttons 16 and secondary input buttons 18 may be displayed. The buttons 16, 18 may be touch input buttons when the digital device 12 includes a touch screen. In other embodiments, a graphical user interface, such as a mouse, may be movable about the screen of the digital device 12 and a selection button may be used to select one or more buttons 16, 18.

As shown in FIG. 1, selected buttons 16b, 18a may be highlighted. In this case, the button 16b for “balance” and the button 18a for “food” may be selected. A first exemplary screen 14a may display a plurality of graphs 20, 22 to show the user how their food intake rates for a given day. For example, a “food excess” pie chart 20 may show total food intake for a given day (in some embodiments, the time period for this graph 20, or any of the aforementioned graphs, may be changed to any number of days, weeks, months, or the like). The graph 20 may show one color for food caloric intake (for example, a black background changing to green as calories are consumed), one color for calories remaining (the black color remaining), and another color when caloric intake exceeds the allotted calories for the given time period (for example, the diagonal lines of graph 20 of FIG. 1 may be green, showing all calories used up for that day, and the vertical lines of graph 20 of FIG. 1 may be red, showing overage). The graph 20 may correspond to the data below the graphs, which may include allowed calories and calories consumed.

The screen 14a may further display graphs 22 that break down food intake into various categories, such as carbohydrates (which, for example, may be further broken down into good and bad carbs), protein and fat. These graphs 22 may be useful for persons on a low fat or a low carb diet. The graphs 22 may be color coded. For example, the good carb and fat graphs of FIG. 1 may be green so show the daily allotment has not yet been consumed, but the bad carb and protein graphs may be red, showing that the daily allotment has been exceeded.

Referring to FIG. 2, a second exemplary screen 14b may be selected when button 18b, “fluid/salt” is selected. Similar to the screen 14a, in this screen 14b, a user may see his or her progress with fluid and salt intake. This progress, for example, may be shown in pie charts 24, 26. The pie charts 24, 26 may be color coded to help reveal desired intake, current intake overage, and current intake shortfalls. These charts 24, 26 may be helpful, for example, in monitoring salt intake for those on a salt-restrictive diet.

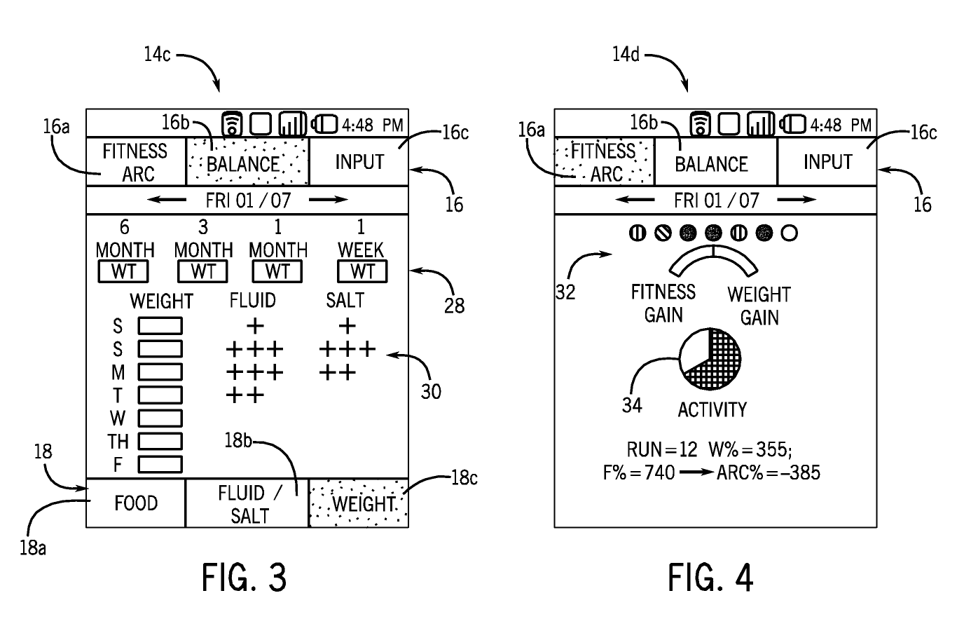

Referring to FIG. 3, a third exemplary screen 14c may be selected when button 18c, “weight” is selected. This screen 14c may include a histogram 28 of the user's weight over a number of predefined intervals. In addition, the screen 14c may include a current week weight history graph 30 which may further include salt and fluid intake beside each day's weight measurement. The screen 14c may be helpful to not only monitor weight, but to gain an understanding between the interaction of fluid and salt intake and weight.

Referring to FIG. 4, a fourth exemplary screen 14d may be selected when button 16a, “fitness arc” is selected. This screen 14d may include a color coded fitness gain/weight gain graph 32. This graph 32 may be, for example, in a semi-circular shape, where one side of the semi-circle indicates fitness gain and the other side of the semi-circle indicates weight gain. The semi-circle may be divided in the middle, where a green color may fill the fitness gain side when excess fitness is achieved for the day, and a red color may fill the weight gain side when weight gain is predicted for the day. The fitness arc 32 may change throughout the day, depending on the user's activity and consumed calories.

Above the semi-circle, a series of color coded dots may appear. These dots may represent the fitness arc 32 results for the prior seven days. For example, the dots may be green to indicate fitness gain for a given day, black for neutral, or red for weight gain.

The screen 14d may also include an activity chart 34 which may show the amount of activity achieved for a given day. The activity chart 34 may be a pie chart that fills in during the day as activity is recorded.

The prediction made in determining the fitness arc 32 (the prediction being either fitness gain or weight gain) may be confirmed through the input of the user's daily (or other periodic entry) weight. If the system's prediction is incorrect, the system may learn and adapt to the user's circumstances. For example, if the user underestimates their intake portions (entered as described below), the user may gain weight, even though the system 10 may predict fitness gain. The system may recognize this and adjust the fitness arc accordingly. Similarly, if the user does not burn calories as rapidly as initially predicted (and therefore a fitness gain initial prediction may result in weight gain), the software can adjust and calculate caloric burn at a slower rate as compared to activity. Over time, the software can become customized for a particular user and may more accurately predict weight gain and fitness gain.

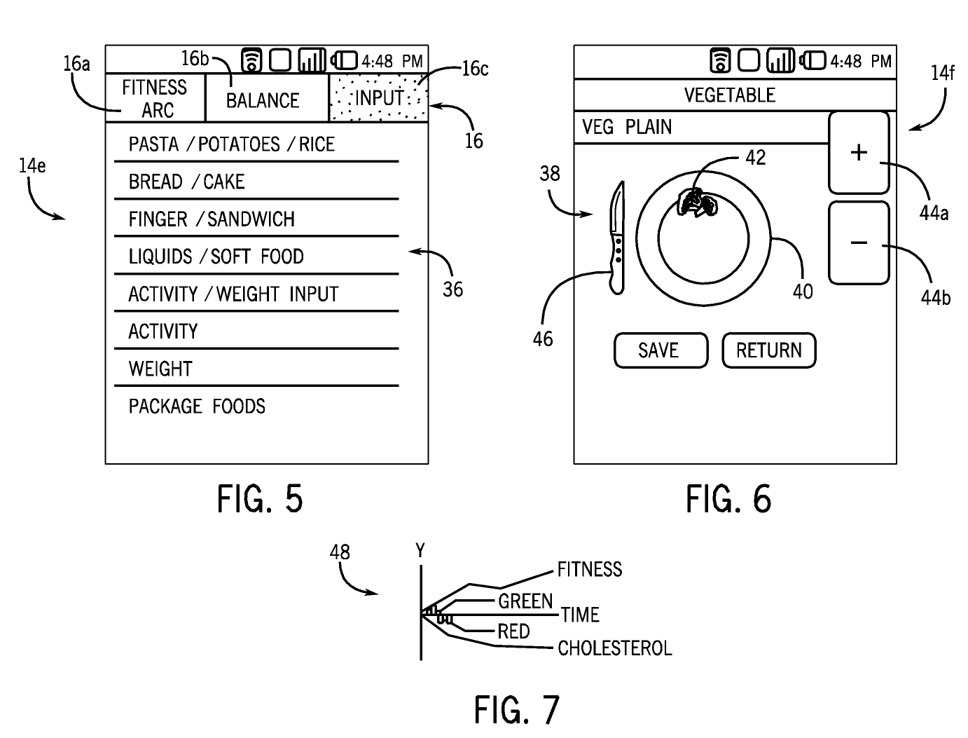

Referring to FIGS. 5 and 6, when a user consumes foods, calorie input is not needed. Instead, as shown in exemplary screen 14e, the user may select the type of food from a list 36. Once the type of food is selected, as shown in exemplary screen 14f, a portion chart 38, including a plate 40, is shown (with a knife 46, or some other utensil for a size reference), and the user may place more or less food 42 on the plate 40 with portion control buttons 44a, 44b. This allows the user to visually input the type and portion of food, without the need of measuring, weighing or knowing the caloric content of the food. In some embodiments, the list 36 may have an option to add a new food item to the list, or manually enter a caloric intake. The user may be able to enter a “proposed” meal to determine the meal's effect on the user's fitness goals. The user may then edit the proposed meal or change the proposed meal into an actual meal if the meal is consumed.

Referring to FIG. 7, the system 10 may provide a histogram 48 showing various parameters. For example, overall fitness and cholesterol may be shown over time with bar graphs for each day's result. Other parameters may be selected, depending on the user's preference and health needs. Of course, for the graph to show items like cholesterol or blood pressure or the like, the user may manually enter such data as it is determined.

The present invention may include one or more accelerometers for measuring the activity of the user. The accelerometers may use, for example, Bluetooth™ technology for transmitting activity information to the device 12. In some embodiments, the accelerometer may include memory for storing activity information (for example, activity amount, time, duration, and the like). The memory may store this information until the accelerometer is brought within transmission range of the device 12. The data from the accelerometer may vary depending on the exercise performed by the user. In some embodiments, the accelerometer may recognize the type of exercise based on certain movements or based on the position the accelerometer is placed on a particular band that is wrapped around the user's wrist or ankle, for example.

In some embodiments, the device 12 may not only receive signals from an accelerometer, but also from other devices. For example, a scale may be adapted to send weight values to the device, thereby automatically recording the user's weight. Similarly, when items such as blood pressure are recorded, such information may be automatically transmitted to the device 12. In other embodiments, the device 12 may interface with an electronic patient chart, allowing the user to upload information from their medical chart directly into the device 12.

It should be understood, of course, that the foregoing relates to exemplary embodiments of the invention and that modifications may be made without departing from the spirit and scope of the invention as set forth in the following claims.

What is claimed is:

1. A method for managing a user's health, comprising:
entering consumed calories into a device, the consumed calories being entered as a graphical representation of a food portion;
inputting activity into the device; and
predicting the user's fitness level based on calories consumed and calories burned due to activity.

2. The method of claim 1, further comprising determining the user's activity through signals received from an accelerometer worn by the user.

3. The method of claim 1, further comprising measuring a weight of the user on a periodic basis.

4. The method of claim 3, further comprising adjusting the user's fitness level prediction based on historic measurements of the calories consumed, the calories burned and the weight of the user.

5. The method of claim 4, further comprising generating graphs showing at least one of caloric intake, food type intake, fluid intake, salt intake, activity, and fitness level.

6. The method of claim 5, wherein the graphs are color-coded to visually represent various aspects of the user's health.

7. The method of claim 5, wherein at least one of the graphs includes a fitness arc showing fitness gain and weight gain on a daily basis.

8. The method of claim 7, wherein the fitness arc includes a historical indication of daily results of the fitness arc for a predetermined period of time.

9. The method of claim 1, wherein the activity is transmitted via wireless technology from an accelerometer worn by a user.

10. A system for managing a user's health, the system comprising:
a device adapted to run software, the software including:
program code adapted to receive consumed calories entered by the user, the program code providing a graphical representation of a food portion, wherein the food portion may be graphically adjusted by the user;
program code adapted to receive an input of activity of the user;
program code adapted to receive an input of weight of the user;
program code adapted to predict the user's fitness level based on calories consumed and calories burned due to activity; and
program code adapted to adjust the user's fitness level prediction based on historic measurements of the calories consumed, the calories burned and the weight of the user.

11. The system of claim 10, wherein the device includes a touch screen input to allow the user to input data into the device.

12. The system of claim 10, wherein the software further includes program code adapted to generate graphs showing at least one of caloric intake, food type intake, fluid intake, salt intake, activity, and fitness level.

13. A method for managing a user's health, comprising:
receiving an entry of consumed calories into a device, the consumed calories being entered as a graphical representation of a food portion;
receiving an entry of activity into the device;
receiving an entry of a weight of the user on a periodic basis;
predicting the user's fitness level based on calories consumed and calories burned due to activity; and
adjusting the user's fitness level prediction based on historic measurements of the calories consumed, the calories burned and the weight of the user.

14. The method of claim 13, further comprising determining the user's activity through signals received from an accelerometer worn by the user.

15. The method of claim 13, further comprising generating graphs showing at least one of caloric intake, food type intake, fluid intake, salt intake, activity, and fitness level, wherein the graphs are color-coded to visually represent various aspects of the user's health.

16. The method of claim 13, further comprising generating a histogram showing predefined health parameters.
